(19) United States
(12) Patent Application Publication
(10) Pub. No.: US 2026/0121126 A1
(43) Pub. Date: Apr. 30, 2026

(54) SECONDARY BATTERY

(71) Applicant: SAMSUNG SDI CO., LTD., Yongin-si (KR)

(72) Inventor: Mi Sun LEE, Yongin-si (KR)

(21) Appl. No.: 19/217,599

(22) Filed: May 23, 2025

(30) Foreign Application Priority Data
Oct. 31, 2024 (KR) 10-2024-0152533

(51) Int. Cl. H01M 10/0583; B60L 50/60; H01M 50/105; H01M 50/627

(52) U.S. Cl. CPC H01M 10/0583; H01M 50/105; H01M 50/627; B60L 50/66; H01M 2220/20

(57) ABSTRACT

The present disclosure relates to a secondary battery, including: an electrode assembly including a plurality of first electrode plates, a plurality of second electrode plates, and a separator, the separator folded in a zigzag geometry and interposed between each of the plurality of first electrode plates and each of the plurality of second electrode plates; a case accommodating the electrode assembly; and an adhesive member disposed on at least one side of an outer surface of the electrode assembly, wherein the electrode assembly has an adhesion region in which an outermost end region of the separator is adhered, and wherein the adhesive member is disposed on at least a portion of the adhesion region.

### CROSS-REFERENCE TO RELATED APPLICATION

The present application claims priority to and the benefit under 35 U.S.C § 119(a)-(d) of Korean Application No. 10-2024-0152533, filed in the Korean Intellectual Property Office on Oct. 31, 2024, the entire disclosure of which is incorporated herein by reference.

### BACKGROUND

### 1. Field

The present disclosure relates to a secondary battery.

### 2. Description of the Related Art

Unlike a primary battery, a secondary battery may be charged and discharged. Low-capacity secondary batteries having a single battery cell packaged in the form of a pack are widely employed in small, portable electronic devices, such as smart phones, feature phones, laptop computers, digital cameras, camcorders, and the like, while large-capacity secondary batteries are widely used as power sources for driving motors in hybrid vehicles, electric vehicles, and the like, as well as batteries for power storage. The secondary battery includes an electrode assembly consisting of a positive electrode and a negative electrode, a case that accommodates the electrode assembly, and electrode terminals connected to the electrode assembly.

The above information disclosed in this Background section is only for enhancement of understanding of the background of the invention and therefore it may contain information that does not constitute prior art.

### SUMMARY

Embodiments of the present disclosure provide a secondary battery in which an electrode assembly portion, susceptible to breakage when pressure is applied, is reinforced.

However, the technical problems to be achieved in the embodiment of the disclosure are not limited to the technical problems mentioned above, and other technical problems not mentioned herein will be clearly understood from the following description by those skilled in the art to which the disclosure belongs.

A secondary battery according to an embodiment of the present disclosure for solving the above technical problem, may include: an electrode assembly comprising a plurality of first electrode plates and second electrode plates, and a separator folded in a zigzag shape and interposed between the first electrode plates and the second electrode plates; a case accommodating the electrode assembly; and an adhesive member provided on at least one side of an outer surface of the electrode assembly, wherein the electrode assembly includes a fusion region in which the outermost end region of the separator is fused, and the adhesive member may be provided to include at least a portion of the fusion region.

Embodiments of the present disclosure provide a secondary battery, including: an electrode assembly including a plurality of first electrode plates, a plurality of second electrode plates, and a separator, the separator folded in a zigzag geometry and interposed between each of the plurality of first electrode plates and each of the plurality of second electrode plates; a case accommodating the electrode assembly; and an adhesive member disposed on at least one side of an outer surface of the electrode assembly, wherein the electrode assembly has an adhesion region in which an outermost end region of the separator is adhered, and wherein the adhesive member is disposed on at least a portion of the adhesion region.

In some embodiments, the adhesive member may be provided on a first side of the electrode assembly where the outermost end region of the separator is located and on a second side where the second side is located on the other side of the first side.

In some embodiments, the adhesive member is disposed on a first side of the electrode assembly where the outermost end region of the separator is located and disposed on a second side opposite to the first side.

In some embodiments, the fusion region may be located in at least one of a plurality of bent regions into which the separator is folded.

In some embodiments, the adhesion region is located in at least one of a plurality of bent regions.

In some embodiments, in the electrode assembly, the first electrode plates or the second electrode plates may be exposed, and the adhesive member may be provided on the outer surfaces of the bent regions of the separator on the second side and at the ends of the first electrode plates or the ends of the second electrode plates, and may be provided at the outermost end region of the separator on the first side, on the outer surfaces of the bent regions of the separator other than the fusion region, and at the end of the front end region of the separator, the ends of the first electrode plates, and the ends of the second electrode plates.

In some embodiments, the plurality of first electrode plates or the plurality of second electrode plates are exposed, wherein the adhesive member is disposed on an outer surface of the plurality of bent regions on the second side, and disposed at an end of the plurality of first electrode plates or an end of the plurality of second electrode plates, and wherein the adhesive member is disposed at the outermost end region of the separator on the first side, on the outer surface of the plurality of bent regions other than the adhesion region, at an end of a front end region of the separator, an end of the plurality of first electrode plates, and/or an end of the plurality of second electrode plates.

In some embodiments, in the electrode assembly, the separator may be exposed, and the adhesive member the adhesive member may be provided on the outer surfaces of the bent regions of the separator on the second side and at the ends of the first electrode plates or the ends of the second electrode plates, and may be provided at the outermost end region of the separator on the first side, on the outer surfaces of the bent regions of the separator other than the fusion region, and at the end of a front end region of the separator, and the ends of the first electrode plates or the ends of the second electrode plates on the second side where the adhesive member is not provided.

In some embodiments, the separator is exposed, wherein the adhesive member is disposed on an outer surface of the plurality of bent regions on the second side, and disposed at an end of the plurality of first electrode plates or an end of the plurality of second electrode plates, and wherein the adhesive member is disposed at the outermost end region of the separator on the first side, on the outer surface of the plurality of bent regions other than the adhesion region, at an end of a front end region of the separator, an end of the plurality of first electrode plates, and/or an end of the plurality of second electrode plates.

In some embodiments, the fusion region may be located in the entirety of the bent regions into which the separator is folded and the end of the front end region of the separator.

In some embodiments, the adhesion region is located along an entirety of the plurality of bent regions and located at an end of a front end region of the separator.

In some embodiments, in the electrode assembly, the first electrode plates or the second electrode plates may be exposed, and the adhesive member may be provided on the outer surfaces of the bent regions of the separator on the second side and at the ends of the first electrode plates or the ends of the second electrode plates, and may be provided at the outermost end region of the separator on the first side and the ends of the first electrode plates or the ends of the second electrode plates.

In some embodiments, the plurality of first electrode plates or the plurality of second electrode plates are exposed, wherein the adhesive member is disposed on an outer surface of the plurality of bent regions on the second side, and disposed at an end of the plurality of first electrode plates or an end of the plurality of second electrode plates, and wherein the adhesive member is disposed at the outermost end region of the separator on the first side, an end of the plurality of first electrode plates, and/or an end of the plurality of second electrode plates.

In some embodiments, in the electrode assembly, the separator may be exposed, and the adhesive member may be provided at the bent regions of the separator on the second side and the ends of the first electrode plates or the ends of the second electrode plates, and may be provided at the outermost end region of the separator on the first side.

In some embodiments, the separator is exposed, wherein the adhesive member is disposed at the plurality of bent regions on the second side, and disposed at an end of the plurality of first electrode plates or an end of the plurality of second electrode plates, and wherein the adhesive member is disposed at the outermost end region of the separator on the first side.

In some embodiments, the outermost end region of the separator and the front end region of the separator may have ends in contact with each other.

In some embodiments, the outermost end region and the front end region have ends in contact with each other.

In some embodiments, the length of the outermost end region of the separator may be less than or equal to the stacking-direction height of the electrode assembly.

In some embodiments, a length of the outermost end region is less than or equal to a stacking-direction height of the electrode assembly.

In some embodiments, the adhesive member may be provided on the outer surface of the outermost end region of the separator.

In some embodiments, the adhesive member is disposed on an outer surface of the outermost end region of the separator.

In some embodiments, the adhesive member may be provided on the inner side of the outermost end region of the separator.

In some embodiments, the adhesive member is disposed on an interior side of the outermost end region of the separator.

In some embodiments, the adhesive member may be along the periphery at a location of at least a portion in the longitudinal direction of the electrode assembly.

In some embodiments, the adhesive member is disposed along a periphery of at least a portion of the electrode assembly in the longitudinal direction.

In some embodiments, the adhesive member may be provided on the entire outer surface of the electrode assembly.

In some embodiments, the adhesive member is disposed on an entirety of the outer surface of the electrode assembly.

In some embodiments, the adhesive member may be provided in a region of the entire outer surface of the electrode assembly excluding an electrolyte injection region.

In some embodiments, the adhesive member is disposed on an entirety of the outer surface of the electrode assembly excluding an electrolyte injection region.

In some embodiments, the case may include: wing portions formed on one side and the other side of the case as a front part and a rear part of the case are combined; and a receiving portion provided between the wing portions to receive the electrode assembly therein, and the adhesive member may be provided at the wing portions or in the receiving portion.

In some embodiments, the case includes: a plurality of wing portions formed at least one side of the case; and a receiving portion between each of the plurality of wing portions, wherein the adhesive member is disposed at the plurality of wing portions or in the receiving portion.

In some embodiments, the adhesive member may include at least one of an adhesive tape and an adhesive.

In some embodiments, the adhesive member includes an adhesive tape or an adhesive.

In some embodiments, the adhesive member may be provided in a specific pattern shape at some portions of attachment regions where the wing portions and the receiving portion contact each other, or may be provided in the entirety of the attachment regions.

In some embodiments, the adhesive member is disposed in a specific pattern on a portion of an attachment region where the plurality of wing portions and the receiving portion are in contact with each other.

In some embodiments, in the electrode assembly, the first electrode plates may be disposed on the lower side of the separator, the second electrode plates may be disposed on the upper side of the separator, and the separator or the first electrode plates may be exposed to the front and rear sides of the electrode assembly.

In some embodiments, the plurality of first electrode plates is disposed on a lower side of the separator, wherein the plurality of second electrode plates is disposed on an upper side of the separator, and wherein the separator or the plurality of first electrode plates are exposed to a front side and/or a rear side of the electrode assembly.

In some embodiments, in the electrode assembly, the second electrode plates may be disposed on the lower side of the separator, the first electrode plates may be disposed on the upper side of the separator, and the separator or the second electrode plates may be exposed to the front and rear sides of the electrode assembly.

In some embodiments, the plurality of second electrode plates is disposed on a lower side of the separator, wherein the plurality of first electrode plates is disposed on an upper side of the separator, and wherein the separator or the plurality of second electrode plates are exposed to a front side and/or a rear side of the electrode assembly.

According to the present disclosure, by providing an adhesive member to bent regions and cell wing portions of an electrode assembly inside a pouch, portions of the electrode assembly that are prone to breakage when pressure is applied can be reinforced, thereby preventing breakage and short circuit.

However, the technical effects to be achieved in the embodiment of the disclosure are not limited to the technical problems mentioned above, and other technical effects not mentioned herein will be clearly understood from the following description by those skilled in the art to which the disclosure belongs.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing the structure of a secondary battery according to embodiments of the present disclosure.

FIG. 2 is a plan view showing an electrode assembly according to embodiments of the present disclosure.

FIG. 3 is a cross-sectional view showing the electrode assembly of the secondary battery along 3-3′ of FIG. 1 according to embodiments of the present disclosure.

FIG. 4 is a cross-sectional view of an electrode assembly with a separator in the electrode assembly of the secondary battery according to embodiments of the present disclosure.

FIG. 5 is a cross-sectional view of an electrode assembly in which the outermost end of a separator and a leading-edge region are brought into contact in the electrode assembly of the secondary battery according to embodiments of the present disclosure.

FIG. 6 is a cross-sectional view of an electrode assembly with a separator in the electrode assembly of the secondary battery according to embodiments of the present disclosure.

FIG. 7 is a cross-sectional view of an electrode assembly in which an adhesive member is provided on the inner side of the outermost end of a separator in the electrode assembly of the secondary battery according to embodiments of the present disclosure.

FIG. 8 is a plan view showing an electrode assembly according to embodiments of the present disclosure.

FIG. 9 is a cross-sectional view of the electrode assembly of the secondary battery shown in FIG. 8 according to embodiments of the present disclosure.

FIG. 10 is a cross-sectional view showing a secondary battery according to embodiments of the present disclosure, in which an adhesive member is provided in a wing portion and a receiving portion.

FIG. 11 is a perspective view showing an adhesive member attached to at least one of a wing portion and a receiving of the secondary battery according to embodiments of the present disclosure.

FIG. 12 is a perspective view showing an adhesive member attached to at least one of a wing portion and a receiving portion of a secondary battery according to embodiments of the present disclosure.

FIG. 13 shows a smartphone equipped with a secondary battery according to embodiments of the present disclosure.

FIG. 14 is a perspective view showing a battery module according to embodiments of the present disclosure.

FIGS. 15A and 15B are perspective views of a battery pack according to embodiments of the present disclosure.

FIG. 16A is a perspective view showing a vehicle body and vehicle components according to embodiments of the present disclosure. FIG. 16B is a side view showing a vehicle body and vehicle components according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application. In addition, it will be understood that the terms “comprise or include” and/or “comprising or including,” when used in this specification, specify the presence of stated features, integers, steps, operations, elements, and/or components but do not preclude the presence or addition of one or more other features, integers, steps, operations, elements, components, and/or groups thereof. In addition, when describing embodiments of the present disclosure, the wording “may ˜” or “may be˜” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” etc., may be used herein to describe various components, these components should not be limited by these terms. These terms are used to distinguish one component from another component. Thus, unless otherwise defined, a first component described below could be termed a second component, without departing from the spirit and scope of the present disclosure.

Throughout the specification, the singular forms are intended to include the plural forms as well, unless the context clearly indicates otherwise.

The arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

Also, it will be understood that when an element is referred to as being “coupled to,” “linked to,” or “connected to” another element, these elements can be directly coupled or connected to each other, another intervening element may be present therebetween, or the respective elements may be coupled, linked, or connected to each other through another elements. In addition, it will be understood that when an element is referred to as being electrically coupled to another element, the element can be directly connected to another element or an intervening element may be present therebetween such that the element and another element are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

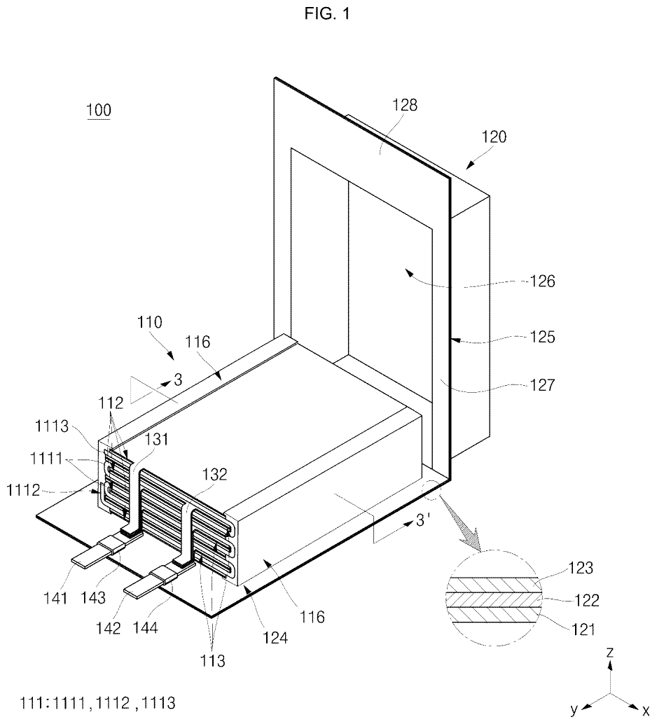

FIG. 1 is a perspective view showing the structure of a secondary battery 100 according to embodiments of the present disclosure.

As shown in FIG. 1, the secondary battery 100 includes an electrode assembly 110 and a case 120 that accommodates the electrode assembly 110.

The electrode assembly 110 may include a separator 111, a first electrode plate 112, and a second electrode plate 113. The separator 111 may be interposed between the first electrode plate 112 and the second electrode plate 113. In some embodiments, the electrode assembly 110 may be formed by stacking the separator 111, the first electrode plate 112, and the second electrode plate 113, which are formed in a thin plate shape or film shape. In some examples, the electrode assembly 110 may include a plurality of first electrode plates 112 and second electrode plates 113, and the separator 111 may be folded in a zigzag geometry and interposed between the first electrode plates 112 and the second electrode plates 113. In some embodiments, the electrode assembly 110 may have one or more electrode assemblies 110 stacked so as to be adjacent to each other or one another to then be accommodated inside the case 120, and the number of electrode assemblies 110 is not limited in the present disclosure. In some embodiments, in the electrode assembly 110, the first electrode plate 112 may serve as a negative electrode, and the second electrode plate 113 may serve as a positive electrode. In some embodiments, in the electrode assembly 110, the first electrode plate 112 may serve as a positive electrode, and the second electrode plate 113 may serve as a negative electrode.

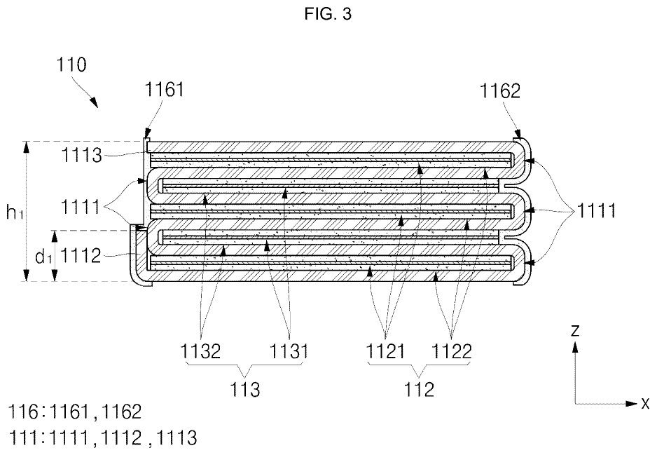

The first electrode plate 112 may be formed by applying a first electrode active material including graphite or carbon on a first electrode current collector including a metal foil including copper, a copper alloy, nickel, or a nickel alloy. The first electrode plate 112 may include a first active material layer 1122 (refer to FIG. 3) to which a first electrode active material is applied. The first electrode plate 112 may include a first uncoated portion, which is a region to which the first electrode active material is not applied. In some embodiments, the first electrode plate 112 may be formed by applying a first electrode active material to at least one of the upper surface (+z direction based on FIG. 1) and the lower surface (−z direction based on FIG. 1). In some embodiments, the first electrode plate 112 may be formed by applying the first electrode active material in a specific pattern.

The first electrode plate 112 may include a first electrode tab 141 electrically connected to the first uncoated portion. In some embodiments, the first electrode tab 141 may have a substantially flat geometry and be fixed (e.g., welded) to the first uncoated portion. In some embodiments, the first electrode tab 141 may be fixed to the first uncoated portion by ultrasonic welding, laser welding, or resistance welding. That is, one end of the first electrode tab 141 may be electrically connected to the first uncoated portion, and the other end of the first electrode tab 141 may protrude and extend outwardly. In some embodiments, the first electrode plate 112 may further include a first substrate tab 131 without a first active material layer 1122 (refer to FIG. 3) formed and extend outwardly by a certain length. The first substrate tab 131 may be connected to the first electrode tab 141. In some embodiments, the first substrate tab 131 may be defined as the first uncoated portion. In some embodiments, the first substrate tab 131 may be formed when manufacturing the first electrode plate 112 by cutting the first electrode plate 112 so as to protrude to one side, and may protrude further than the separator 111 without being separately cut. In some embodiments, instead of the first substrate tab 131, a separate first lead tab may connect the first uncoated portion and the first electrode tab 141.

A negative electrode active material, corresponding to the first electrode active material, may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The second electrode plate 113 may be formed by applying a second electrode active material including graphite or carbon on a second electrode current collector including a metal foil including aluminum or an aluminum alloy. The second electrode plate 113 may include a second active material layer 1132 (refer to FIG. 3) to which a second electrode active material is applied. The second electrode plate 113 may include a second uncoated portion, which is a region to which the second electrode active material is not applied. In some embodiments, the second electrode plate 113 may be formed by applying a second electrode active material to at least one of the upper and lower surfaces. In some embodiments, the second electrode plate 113 may be formed by applying a second electrode active material in a specific pattern.

The second electrode plate 113 may include a second electrode tab 142 electrically connected to a second uncoated portion. In some embodiments, the second electrode tab 142 may have a substantially flat geometry and be fixed (e.g., welded) to the second uncoated portion. In some embodiments, the second electrode tab 142 may be fixed to the second uncoated portion by ultrasonic welding, laser welding, or resistance welding. That is, one end of the second electrode tab 142 may be electrically connected to the second uncoated portion, and the other end of the second electrode tab 142 may protrude and extend outwardly. In some embodiments, the second electrode plate 113 may further include a second substrate tab 132 without a second active material layer 1132 (refer to FIG. 3) formed and extend outwardly by a certain length. The second substrate tab 132 may be connected to the second electrode tab 142. In some embodiments, the second substrate tab 132 may be the second uncoated portion. In some embodiments, the second substrate tab 132 may be formed when manufacturing the second electrode plate 113 by cutting the second electrode plate 113 so as to protrude to one side, and may protrude further than the separator 111 without being separately cut. In some embodiments, instead of the second substrate tab 132, a separate second lead tab may connect the second uncoated portion and the second electrode tab 142.

A positive electrode active material, corresponding to the second electrode material, may include a compound capable of reversibly intercalating/deintercalating lithium (e.g., a lithiated intercalation compound). For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹ _{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

As the current collector, aluminum (Al) may be used, but not limited thereto.

The separator 111 may be interposed between the first electrode plate 112 and the second electrode plate 113 to prevent an electrical short between the first electrode plate 112 and the second electrode plate 113.

Depending on the type of lithium secondary battery, the separator may be present between a positive electrode and a negative electrode. As the separator, polyethylene, polypropylene, polyvinylidene fluoride, or a multilayer film of two or more layers thereof may be used.

The separator 111 may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

In some embodiments, the case 120 may accommodate the electrode assembly 110 and seal the outer periphery of the electrode assembly 110. In some embodiments, the case 120 may be sealed such that edges of the case contact each other or one another to accommodate the electrode assembly 110. The case 120 may include or be referred to as a pouch, a can, an exterior material, or a housing. In some embodiments, the case 120 may have a laminate structure having, for example, a first insulating layer 121, a metal layer 122, and a second insulating layer 123.

In some embodiments, the case 120 may include a first exterior part 124 and a second exterior part 125 having one end connected to the first exterior part 124 and having a recess 126 of a predetermined depth to accommodate the electrode assembly 110. The recess 126 may include or be referred to as a receiving portion. In some embodiments, the peripheries of the first and second exterior parts 124 and 125 corresponding to the outer periphery of the electrode assembly 110 are thermally welded to each other or one another, so that the electrode assembly 110 may be accommodated within the case 120 of approximately a pouch or pocket type.

In some embodiments, the case 120 may be provided to form the first exterior part 124 and the second exterior part 125 by folding the middle of the square plate-shaped case 120 formed integrally along the length of one side. The second exterior part 125 may have a recess 126 of a predetermined depth capable of accommodating the electrode assembly 110 through a press or drawing process, and a sealing area 127 for sealing with the first exterior part 124 may be provided on the outer periphery of the recess 126. The sealing area 127 may exist along one side where the first exterior part 124 and the second exterior part 125 are integrally in contact and along the remaining three sides. In some embodiments, the sealing area 127, on two sides excluding the side where the first electrode tab 141 and the second electrode tab 142 are located and the side where the first exterior part 124 and the second exterior part 125 are integrally in contact, may include or be referred to as wing portions.

In some embodiments, the first substrate tab 131 of the electrode assembly 110 is welded to the first electrode tab 141, and the second substrate tab 132 is welded to the second electrode tab 142. The first electrode tab 141 and the second electrode tab 142 may extend outwardly to a predetermined length relative the case 120 by means of a first tab film 143 and a second tab film 144, respectively. In some embodiments, a region of the case 120 where the first electrode tab 141 and the second electrode tab 142 extend outwardly may also be referred to as a terrace 128. The first electrode tab 141 may include copper or nickel, and the second electrode tab 142 may include aluminum.

The sealing area 127 include a thermal adhesive material, and is structured such that sealing is achieved by adhering thermal adhesive layers to each other. Because the thermal adhesive material may have a relatively weak adhesion to metal, a first tab film 143 and a second tab film 144, in the form of thin films, may be attached to the first electrode tab 141 and the second electrode tab 142, respectively, to be fused with the case 120. As shown in FIG. 1, the form in which the first tab film 143 and the second tab film 144 are attached to the first electrode tab 141 and the second electrode tab 142, respectively, may be defined as a separable tab film, and this sealing structure is referred to as a separable sealing structure.

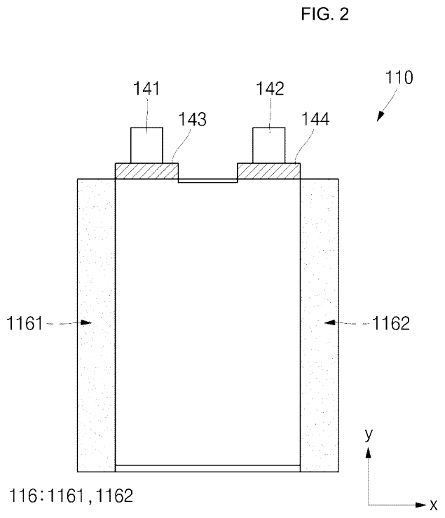

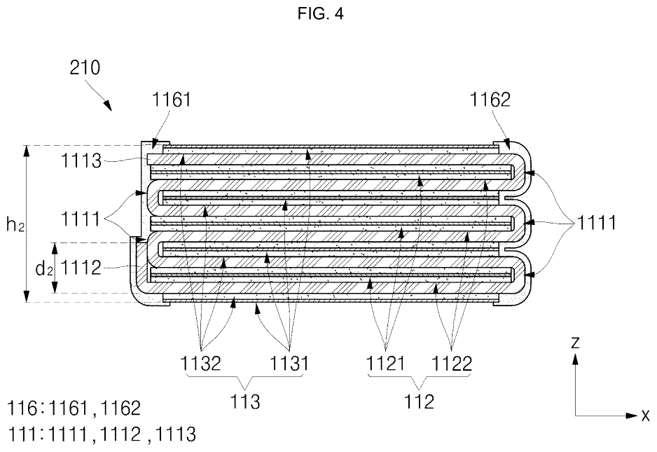

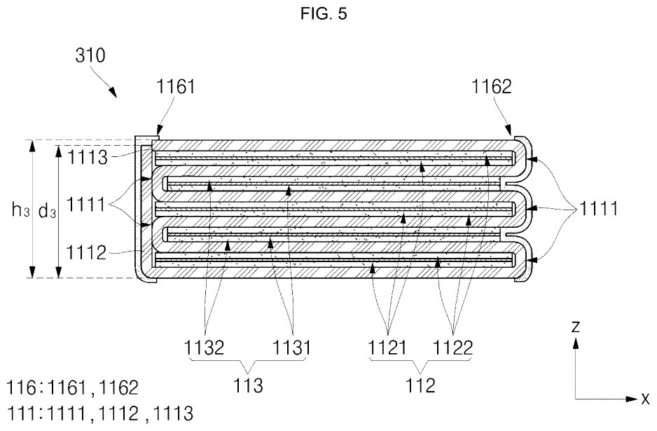

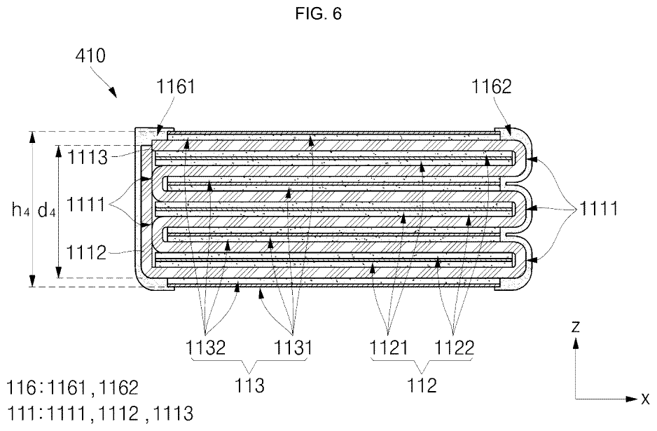

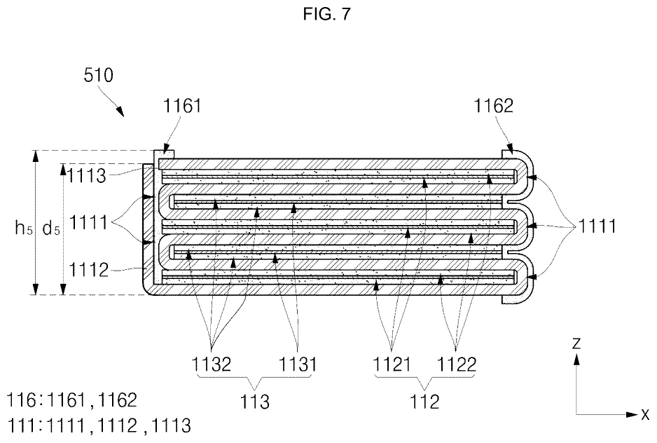

FIG. 2 is a plan view showing an electrode assembly 110 according to embodiments of the present disclosure. FIG. 3 is a cross-sectional view showing the electrode assembly 110 of the secondary battery along 3-3′ of FIG. 1 according to embodiments of the present disclosure. FIG. 4 is a cross-sectional view of an electrode assembly 210 with a separator 111 in the electrode assembly 210 of the secondary battery according to embodiments of the present disclosure. FIG. 5 is a cross-sectional view of an electrode assembly 310 in which the outermost end of a separator 111 and a leading-edge region are brought into contact in the electrode assembly 310 of the secondary battery according to embodiments of the present disclosure. FIG. 6 is a cross-sectional view of an electrode assembly 410 with a separator 111 in the electrode assembly 410 of the secondary battery according to embodiments of the present disclosure. FIG. 7 is a cross-sectional view of an electrode assembly 510 in which an adhesive member is provided on the inner side of the outermost end of a separator 111 in the electrode assembly 510 of the secondary battery according to embodiments of the present disclosure.

In some embodiments, the electrode assembly 110 may include a Z-stack electrode assembly in which a positive electrode plate and a negative electrode plate are inserted on both sides of a separator folded in a Z-stack. In some embodiments, referring to FIG. 1, the electrode assembly 110 may include a separator 111 that is folded in a Z- or S-type geometry and in which a plurality of bent regions 1111 are alternately arranged. In this manner, the separator 111 may be folded multiple times (i.e., folded in a Z- or S-shape) and stacked, and a first electrode plate 112 and a second electrode plate 113 having opposite polarities may be positioned alternately on the lower and upper portions of the folded separator 111, respectively.

The electrode assembly 110 may encounter relatively weak bent regions 1111 being torn during compression evaluation. Referring to FIG. 2, in one embodiment, a bent region 116 may be provided on both sides (one side and the other side located relative to x-axis based on FIG. 2) of the electrode assembly 110 where the bent regions 116 are located. In some embodiments, by providing (or attaching or applying) the bent regions 116 on both sides of the electrode assembly 110, the hardness of the bent regions 116 may be increased so as to better withstand pressure.

In some embodiments, the adhesive member 116 may include a first adhesive member 1161 located on one side of the electrode assembly 110 and a second adhesive member 1162 located on the other side of the electrode assembly 110. The first adhesive member 1161 and the second adhesive member 1162 may extend from the upper edges on one side and the other side of the electrode assembly 110 to the lower edges surrounding the side surfaces. In some embodiments, the adhesive member 116 may be provided along the entire length direction (x-axis direction) of the electrode assembly 110, but the present invention is not limited thereto. In some embodiments, the adhesive member 116 may be provided along at least a portion of the length direction of the electrode assembly 110.

In some embodiments, the adhesive member 116 may include an adhesive tape, a double-sided adhesive tape, a single-sided adhesive tape, or an oriented polystyrene (OPS) tape. In some embodiments, the adhesive tape may include a polypropylene (PP)-based tape, a polyethylene terephthalate (PET)-based tape, an acrylic adhesive tape, a silicone-based adhesive tape, etc. In some embodiments, the adhesive member 116 may include an adhesive such as a binder. In some embodiments, the adhesive may include polyvinylidene fluoride (PVDF), carboxymethyl cellulose (CMC), styrene butadiene rubber (SBR), polyacrylonitrile (PAN), and polyimide (PI).

Referring to FIGS. 3 to 7, the separator 111 may have three bent regions 1111 on the right hand side and two bent regions 1111 on the left hand side, but the present disclosure is not limited to these numbers or configurations. The separator 111 may include one outermost end region 1112 provided at the bottom and one upper end region 1113 provided at the top, but the present disclosure is not limited to this configuration.

In some embodiments, the separator 111 may include or be referred to as a separation membrane or an isolation membrane. In some embodiments, the separator 111 may be provided by coating a ceramic on the surface thereof to improve thermal performance. In some embodiments, the width of the separator 111 may be larger than the widths (in the x direction) of the first electrode plate 112 and the second electrode plate 113 to prevent an electrical short between the first electrode plate 112 and the second electrode plate 113.

In some embodiments, at an early stage of manufacture of the electrode assembly 110, the first electrode plate 112 or the second electrode plate 113 may be laminated starting from the upper end region 1113 of the electrode assembly 110, and the bent regions 1111 may then be formed. Thereafter, the second electrode plate 113 or the first electrode plate 112, which has a polarity opposite to the first electrode plate 112 or the second electrode plate 113, may be stacked on the separator 111 extending horizontally from the bent regions 1111. In some embodiments, the first electrode plate 112 or the second electrode plate 113 may be stacked with the upper end region 1113 of the separator 111 positioned on the right, and then the separator 111 may form the bent regions 1111. Thereafter, the second electrode plate 113 or the first electrode plate 112 having a polarity opposite thereto is stack on top, and then the separator 111 may form the bent regions 1111, and this process may be repeated multiple times. In some embodiments, the upper end region 1113 may be referred to as a leading edge of the separator 111.

In some embodiments, at an early stage of manufacture of the electrode assembly 110, the outermost end region 1112 of the separator 111 may extend to the outside of the electrode assembly 110 after repeating the process of bending the separator 111 after stacking the first electrode plate 112 or the second electrode plate 113. A relatively large gap or space may exist between the ends on both sides of the first electrode plate 112 and the second electrode plate 113 and the bent regions 1111 of the separator 111.

Accordingly, when the electrode assembly 110 is inserted into the case 120, the outermost end region 1112 of the separator 111 may be susceptible to damage. Also, a relatively large gap may exist between the ends of both sides of the first electrode plate 112 and the second electrode plate 113 and the bent regions 1111 of the separator 111. Accordingly, the Z-stack electrode assembly 110 may be relatively fragile compared to a coil-type electrode assembly, thus the electrode assembly 110 may be loosened when subjected to an external impact, such as dropping. Internal resistance increases as the electrode assembly 110 is loosened, deteriorating battery performance. Due to an increased widthwise length, it may be difficult to obtain desired capacity.

Accordingly, in some embodiments, a thermal adhesion process using a heat block and/or hot air may be performed. In some embodiments, the outermost end region 1112 of the separator 111 may be bent in an upward direction (z direction) and thermally adhered to the bent regions 1111 of the separator 111. In some embodiments, the outermost end region 1112 of the separator 111 may be thermally adhered to one of the bent regions 1111. In some embodiments, as the result of the thermal adhesion process, the bent regions 1111 of the separator 111 may include a thermal shrinkage region.

In some embodiments, in the electrode assembly 110, the outermost end region 1112 of the separator 111 is folded upward and then adhered to the bent regions 1111 of the separator 111 preventing the Z stack from loosening, improving the manufacturing processability and safety, and protecting the side surface of an electrode plate. By allowing the remaining portions of the bent regions 1111 on both sides of the separator 111 in the electrode assembly 110 to be thermally shrunk, reducing the width of the Z stack, a secondary battery 100 may have increased battery capacity and be safe from external impacts (e.g., dropping).

Referring to FIG. 3, the electrode assembly 110 may include a second electrode plate 113 disposed on the lower side of the separator 111 and a first electrode plate 112 disposed on the upper side of the separator 111. The electrode assembly 110 may be unfolded, and the second electrode plate 113 may be disposed on the lower side of the separator 111, and the first electrode plate 112 may be disposed on the upper side of the separator 111. In some embodiments, bent regions 1111 may be provided on one side of the separator 111 interposed between the first and second electrode plates 112 and 113. In some embodiments, the electrode assembly 110 may have the separator 111 exposed.

In some embodiments, the electrode assembly 110 may include an adhesion region in which the outermost end region 1112 of the separator 111 is adhered. In some embodiments, the adhesion region may be located at least in one of a plurality of bent regions 1111 into which the separator 111 is folded. In some embodiments, the bent regions 1111 may refer to portions where the separator 111 is folded. Depending on the number of times the separator 111 is folded, a plurality of bent regions 1111 may be formed on one side and the other side.

In some embodiments, the adhesive member 116 may be disposed on a first side (the left hand side of FIG. 3) where the outermost end region 1112 of the electrode assembly 110 is located, and disposed on a second side (the right hand side of FIG. 3), which is the opposite side of the first side. In some embodiments, the adhesive member 116 may be disposed on the first side and/or the second side of the electrode assembly 110. In some embodiments, the adhesive member 116 may wrap around the side surface of the electrode assembly 110 from the upper edge and cover down to the lower edge. In some embodiments, the adhesive member 116 may extend along the entirety, in the longitudinal direction (y-axis direction in FIG. 1), of the side surface of the electrode assembly 110 or along one or more portions, in the longitudinal direction, of the side surface of the electrode assembly 110. In some embodiments, the adhesive member 116 may be disposed in a central region of the side surface of the electrode assembly 110.

In some embodiments, the adhesive member 116 may include a first adhesive member 1161 disposed on the first side and a second adhesive member 1162 disposed on the second side. The first adhesive member 1161 may be disposed at the outermost end region 1112 of the separator 111 on the first side, the bent regions 1111 of the separator 111 other than the fusion region, the end of the front end region of the separator 111, and/or the end of the first electrode plate 112. In some embodiments, the second adhesive member 1162 may be disposed at the bent regions 1111 of the separator 111 on the second side and/or the end of the second electrode plate 113.

The present disclosure is not limited to that shown in FIG. 3, and the electrode assembly 110 may have the first electrode plate 112 disposed on the lower side of the separator 111 and the second electrode plate 113 disposed on the upper side of the separator 111. In some embodiments, the first adhesive member 1161 may be disposed at the outermost end region 1112 of the separator 111 on the first side, the bent regions 1111 of the separator 111 other than the fusion region, the end of the front end region of the separator 111, and/or the end of the second electrode plate 113. In some embodiments, the second adhesive member 1162 may be disposed at the bent regions 1111 of the separator 111 on the second side and/or the end of the first electrode plate 112.

In some embodiments, the length (d₁) of the outermost end region 1112 of the electrode assembly 110 may be less than the height (in the z-axis direction) (h₁) of the electrode assembly 110.

Referring to FIG. 4, an electrode assembly 210 may include a second electrode plate 113 disposed on the lower side of a separator 111 and a first electrode plate 112 disposed on the upper side of the separator 111. The electrode assembly 210 may be unfolded, and the second electrode plate 113 may be disposed on the lower side of the separator 111 and the first electrode plate 112 may be disposed on the upper side. In some embodiments, bent regions 1111 may be provided on one side of the separator 111 interposed between the first and second electrode plates 112 and 113. In some embodiments, the electrode assembly 210 may have the second electrode plate 113 exposed. In some embodiments, the second electrode plate 113 is exposed upward and downward, and may have an active material coated on only one side. In some embodiments, a second electrode current collector plate 1131 may be exposed upward and downward. In some embodiments, a second uncoated portion may be exposed upward and downward.

In some embodiments, the electrode assembly 210 may include an adhesion region in which the outermost end region 1112 of the separator 111 is adhered. In some embodiments, the adhesion region may be located in at least one of a plurality of bent regions 1111 in which the separator 111 is folded. In some embodiments, the bent regions 1111 may refer to portions where the separator 111 is folded. Depending on the number of times the separator 111 is folded, a plurality of bent regions 1111 may be formed on one side and the other side.

In some embodiments, the adhesive member 116 may be disposed on a first side (the left hand side of FIG. 4) where the outermost end region 1112 of the electrode assembly 210 is located, and disposed on a second side (the right hand side of FIG. 4), which is the opposite side of the first side. In some embodiments, the adhesive member 116 may be disposed on the first side and/or the second side of the electrode assembly 210. In some embodiments, the adhesive member 116 may wrap around the side surface of the electrode assembly 210 from the upper edge and cover down to the lower edge. In some embodiments, the adhesive member 116 may be extend along the entirety, in the longitudinal direction (y-axis direction in FIG. 1), of the side surface of the electrode assembly 210 or along one or more portions, in the longitudinal direction, of the side surface of the electrode assembly 210. In some embodiments, the adhesive member 116 may be disposed in a central region of the side surface of the electrode assembly 210.

In some embodiments, the adhesive member 116 may include a first adhesive member 1161 disposed on the first side and a second adhesive member 1162 disposed on the second side. The first adhesive member 1161 may be disposed at the outermost end region 1112 of the separator 111 on the first side, the bent regions 1111 of the separator 111 other than the fusion region, the end of the front end region of the separator 111, the end of the first electrode plate 112, and/or the end of the second electrode plate 113. In some embodiments, the second adhesive member 1162 may be provided at the bent regions 1111 of the separator 111 on the second side and/or the end of the second electrode plate 113.

The present disclosure is not limited to that shown in FIG. 4, and the electrode assembly 210 may have the first electrode plate 112 disposed on the lower side of the separator 111 and the second electrode plate 113 disposed on the upper side of the separator 111. In some embodiments, the first adhesive member 1161 may be disposed at the outermost end region 1112 of the separator 111 on the first side, the bent regions 1111 of the separator 111 other than the fusion region, the end of the front end region of the separator 111, the end of the first electrode plate 112, and/or the end of the second electrode plate 113. In some embodiments, the second adhesive member 1162 may be provided at the bent regions 1111 of the separator 111 on the second side and/or the end of the first electrode plate 112.

In some embodiments, the length (d₂) of the outermost end region 1112 of the electrode assembly 210 may be less than the height (z-axis direction) (h₂) of the electrode assembly 210.

Referring to FIG. 5, an electrode assembly 310 may include a second electrode plate 113 disposed on the lower side of a separator 111 and a first electrode plate 112 disposed on the upper side of the separator 111. The electrode assembly 310 may be unfolded, and the second electrode plate 113 may be disposed on the lower side of the separator 111, and the first electrode plate 112 may be disposed on the upper side of the separator 111. In some embodiments, bent regions 1111 may be provided on one side of the separator 111 interposed between the first and second electrode plates 112 and 113. In some embodiments, the electrode assembly 310 may have the separator 111 exposed.

In some embodiments, the electrode assembly 310 may include an adhesion region to which an outermost end region 1112 of the separator 111 is adhered. In some embodiments, the adhesion region may be located in the entirety of a plurality of bent regions 1111 into which the separator 111 is folded. In some embodiments, the outermost end region 1112 of the separator 111 and the front end region 1113 of the separator 111 may have ends in contact with each other.

In some embodiments, the adhesive member 116 may be disposed on a first side (the left hand side of FIG. 5) where the outermost end region 1112 of the electrode assembly 310 is located, and disposed on a second side (the right hand side of FIG. 5), which is the opposite side of the first side. In some embodiments, the adhesive member 116 may be disposed on the first side and/or the second side of the electrode assembly 310. In some embodiments, the adhesive member 116 may wrap around the side surface of the electrode assembly 310 from the upper edge to the lower edge. In some embodiments, the adhesive member 116 may extend along the entirety, in the longitudinal direction (y-axis direction in FIG. 1), of the side surface of the electrode assembly 310 along one or more portions, in the longitudinal direction, of the side surface of the electrode assembly 310. In some embodiments, the adhesive member 116 may be disposed in a central region of the side surface of the electrode assembly 310.

In some embodiments, the adhesive member 116 may include a first adhesive member 1161 disposed on the first side and a second adhesive member 1162 disposed on the second side. The first adhesive member 1161 may be disposed at the outermost end region 1112 of the separator 111 on the first side. In some embodiments, the first adhesive member 1161 may be disposed at a portion of the end of the front end region 1113. In some embodiments, the second adhesive member 1162 may be disposed at the bent regions 1111 of the separator 111 on the second side and/or the end of the second electrode plate 113.

The present disclosure is not limited to that shown in FIG. 5, and the electrode assembly 310 may have the first electrode plate 112 disposed on the lower side of the separator 111 and the second electrode plate 113 disposed on the upper side of the separator 111. In some embodiments, the first adhesive member 1161 may be disposed at the outermost end region 1112 of the separator 111 on the first side. In some embodiments, the first adhesive member 1161 may be disposed at a portion of the end of the front end region 1113. In some embodiments, the second adhesive member 1162 may be disposed at the bent regions 1111 of the separator 111 on the second side and/or the end of the first electrode plate 112.

In some embodiments, the length (d₃) of the outermost end region 1112 of the electrode assembly 310 may be less than or equal to the height (z-axis direction) (h₃) of the electrode assembly 310.

Referring to FIG. 6, an electrode assembly 410 may include a second electrode plate 113 disposed on the lower side of a separator 111 and a first electrode plate 112 disposed on the upper side of the separator 111. The electrode assembly 410 may be unfolded, and the second electrode plate 113 may be disposed on the lower side of the separator 111, and the first electrode plate 112 may be disposed on the upper side of the separator 111. In some embodiments, bent regions 1111 may be provided on one side of the separator 111 interposed between the first and second electrode plates 112 and 113. In some embodiments, the electrode assembly 410 may have the second electrode plate 113 exposed. In some embodiments, the second electrode plate 113, exposed upward and downward, may have an active material coated on only one side. In some embodiments, a second electrode current collector plate 1131 may be exposed upward and downward. In some embodiments, the second uncoated portion may be exposed upward and downward.

In some embodiments, the electrode assembly 410 may include an adhesion region to which the outermost end region 1112 of the separator 111 is adhered. In some embodiments, the adhesion region may be located in the entirety of a plurality of bent regions 1111 into which the separator 111 is folded. In some embodiments, the outermost end region 1112 of the separator 111 and a front end region 1113 of the separator 111 may have ends in contact with each other.

In some embodiments, the adhesive member 116 may be disposed on a first side (the left hand side of FIG. 6) where the outermost end region 1112 of the electrode assembly 410 is located, and disposed on a second side (the right hand side of FIG. 6), which is the opposite side of the first side. In some embodiments, the adhesive member 116 may be disposed on the first side and/or the second side of the electrode assembly 410. In some embodiments, the adhesive member 116 may wrap around the side surface of the electrode assembly 410 from the upper edge and cover down to the lower edge. In some embodiments, the adhesive member 116 may extend along the entirety, in the longitudinal direction (y-axis direction in FIG. 1), of the side surface of the electrode assembly 410 or along one or more portions, in the longitudinal direction, of the side surface of the electrode assembly 410. In some embodiments, the adhesive member 116 may be disposed in a central region of the side surface of the electrode assembly 410.

In some embodiments, the adhesive member 116 may include a first adhesive member 1161 disposed on the first side and a second adhesive member 1162 disposed on the second side. The first adhesive member 1161 may be disposed at the outermost end region 1112 of the separator 111 on the first side and/or the end of the second electrode plate 113. In some embodiments, the second adhesive member 1162 may be disposed at a portion of the front end region 1113. In some embodiments, the second adhesive member 1162 may be disposed at the bent regions 1111 of the separator 111 on the second side and/or the end of the second electrode plate 113.

The present disclosure is not limited to that shown in FIG. 6, and the electrode assembly 410 may have the first electrode plate 112 disposed on the lower side of the separator 111 and the second electrode plate 113 disposed on the upper side of the separator 111. In some embodiments, the first adhesive member 1161 may be provided at the outermost end region 1112 of the separator 111 on the first side and/or the end of the first electrode plate 112 In some embodiments, the first adhesive member 1161 may be provided at a portion of the front end region 1113. In some embodiments, the second adhesive member 1162 may be provided at the bent regions 1111 of the separator 111 on the second side and/or at the end of the first electrode plate 112.

In some embodiments, the length (d₄) of the outermost end region 1112 of the electrode assembly 410 may be less than the height (z-axis direction) (h₄) of the electrode assembly 410.

In some embodiments, referring to FIGS. 3 to 6, the adhesive member 116 may be disposed on the outer surface of the outermost end region 1112 of the separator 111.

In some embodiments, referring to FIG. 7, an adhesive member 116 may be disposed on the inner side of an outermost end region 1112 of a separator 111. An electrode assembly 510 may include a second electrode plate 113 disposed below the separator 111 and a first electrode plate 112 disposed on the upper side of the separator 111. The electrode assembly 510 may be unfolded, and the second electrode plate 113 may be disposed on the lower side of the separator 111, and the first electrode plate 112 may be disposed on the upper side of the separator 111. In some embodiments, bent regions 1111 may be provided on one side of the separator 111 interposed between the first and second electrode plates 112 and 113. In some embodiments, the electrode assembly 510 may have the separator 111 exposed. In some embodiments, the electrode assembly 510 may have the second electrode collector plate 1132 of the second electrode plate 113 exposed.

In some embodiments, in the electrode assembly 510, the adhesive member 116 may be interposed between the outermost end region 1112 of the separator 111 and a plurality of bent regions 1111 into which the separator 111 is folded. In some embodiments, the adhesive member 116 may be disposed between the outermost end region 1112 of the separator 111 and the front end region 1113 of the separator 111.

In some embodiments, the length (d₅) of the outermost end region 1112 of the electrode assembly 510 may be less than or equal to the height (z-axis direction) (h₅) of the electrode assembly 510.

In some embodiments, the adhesive member 116 may be disposed on a first side (the left hand side of FIG. 7) where the outermost end region 1112 of the electrode assembly 510 is located, and disposed on a second side (the right hand side of FIG. 7), which is the opposite side of the first side. In some embodiments, the adhesive member 116 may be disposed on the first side and the second side of the electrode assembly 510. In some embodiments, the first adhesive member 1161 may wrap around, from the upper edge of the electrode assembly 510, the end of the front end region 1113 on the inner side of the outermost end region 1112, the end of the first electrode plate 112, and the bent regions 1111. In some embodiments, the second adhesive member 1162 may wrap around the bent regions 1111 and the second electrode plate 113 from the upper edge of the electrode assembly 510 and cover down to the lower edge.

The present disclosure is not limited to that shown in FIG. 7, and the electrode assembly 510 may have the first electrode plate 112 disposed on the lower side of the separator 111 and the second electrode plate 113 disposed on the upper side of the separator 111. In some embodiments, the first adhesive member 1161 may wrap around, from the upper edge of the electrode assembly 510, the end of the front end region 1113 on the inner side of the outermost end region 1112, the end of the second electrode plate 113, and the bent regions 1111. In some embodiments, the second adhesive member 1162 may wrap around the bent regions 1111 and the first electrode plate 112 from the upper edge of the electrode assembly 510 and cover down to the lower edge.

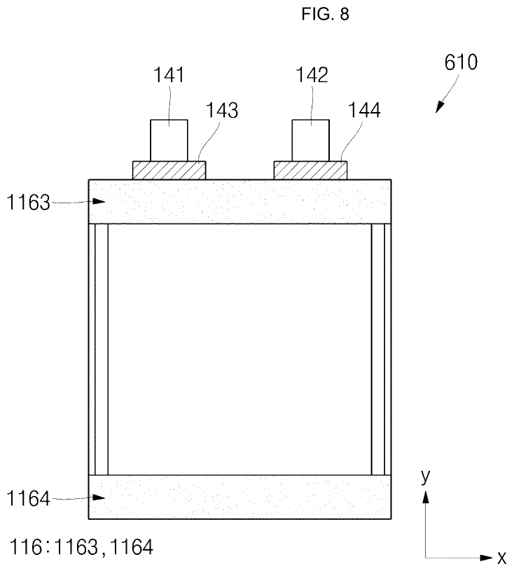

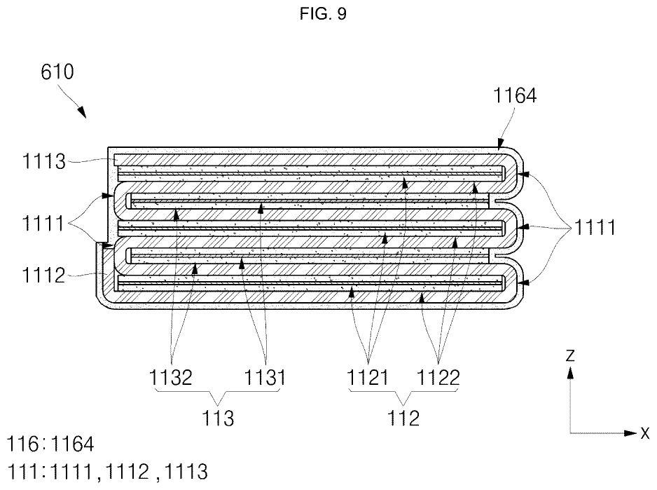

FIG. 8 is a plan view showing an electrode assembly according to embodiments of the present disclosure. FIG. 9 is a cross-sectional view of the electrode assembly of the secondary battery shown in FIG. 8 according to embodiments of the present disclosure.

Referring to FIGS. 8 and 9, an adhesive member 116 may be disposed along the periphery of at least a portion of the electrode assembly 610 in the longitudinal direction (y-axis direction). In some embodiments, the adhesive member 116 may include a third adhesive member 1163 extending along the periphery of an upper region from which electrode tabs 141 and 142 of the electrode assembly 610 protrude. A fourth adhesive member 1164 may extend along the periphery of a lower region. In some embodiments, the adhesive member 116 may extend along the periphery at various locations other than the upper or lower portion, and may extend along the periphery at a central region in the longitudinal direction of the electrode assembly 610.

In some embodiments, the adhesive member 116 may be disposed on the front surface of the electrode assembly 610. In some embodiments, the adhesive member 116 may be disposed on the front surface of the electrode assembly 610, except for at least a portion of the front surface into which an electrolyte may be injected. In some embodiments, an electrolyte, etc. may be injected through a portion from which the adhesive member 116 is absent.

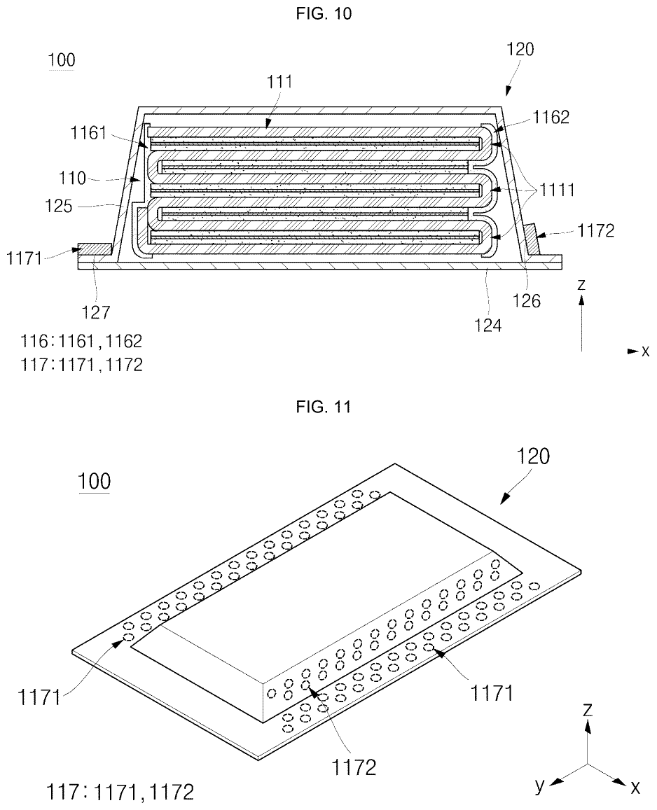

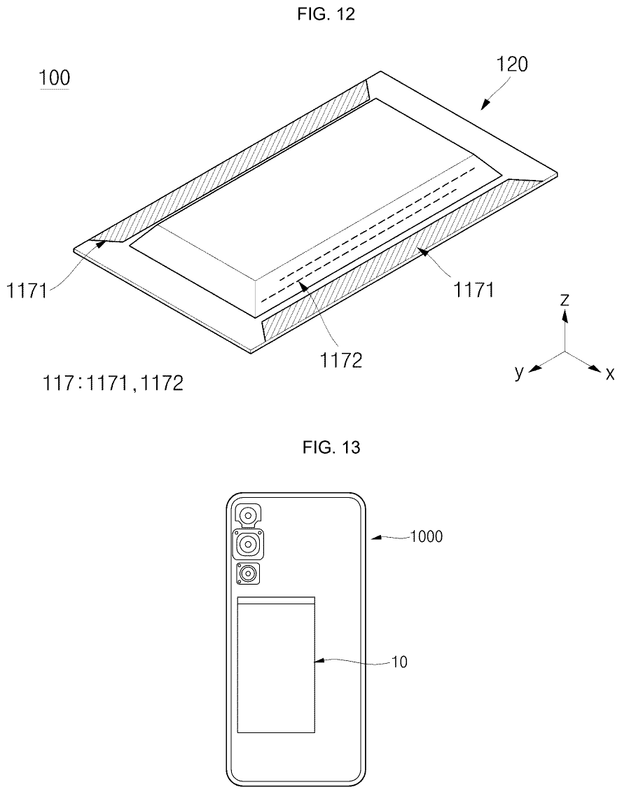

FIG. 10 is a cross-sectional view showing a secondary battery according to embodiments of the present disclosure, in which an adhesive member is provided in a wing portion and a receiving portion. FIG. 11 is a perspective view showing an adhesive member attached to at least one of a wing portion and a receiving of the secondary battery according to embodiments of the present disclosure. FIG. 12 is a perspective view showing an adhesive member attached to at least one of a wing portion and a receiving portion of a secondary battery according to embodiments of the present disclosure.

Referring to FIG. 10, a case 120 may be sealed by thermally adhering the peripheries of first and second exterior parts 124 and 125 with an electrode assembly 110 accommodated in a receiving portion 126 having a certain depth. In some embodiments, a wing portion 127 for sealing the first exterior part 124 may be disposed on the outer periphery of the receiving portion 126. In some embodiments, the wing portion 127 may refer to a sealing area of two sides, excluding a side where the first electrode tab 141 and the second electrode tab 142 are located and excluding a side where the first exterior part 124 and the second exterior part 125 are integrally in contact.

In some embodiments, an adhesive member 116 may be disposed in the electrode assembly 110. An adhesive member 117 may be disposed in the receiving portion 126 and at the wing portion 127 of the case 120. In some embodiments, the wing portion 127 may be folded and attached toward the receiving portion 126, and the adhesive member 117 may be provided in an attachment region where the wing portion 127 and the receiving portion 126 are in contact with each other. In some embodiments, the adhesive member 117 may include a wing portion adhesive member 1171 provided on the wing portion 127 and may include a receiving portion adhesive member 1172 provided on the receiving portion 126.

In some embodiments, FIG. 10 shows that the wing portion adhesive member 1171 is disposed on the first side (the left hand side of FIG. 10), and the receiving portion adhesive member 1172 is disposed on the second side (the right hand side of FIG. 10). In some embodiments, the wing portion adhesive member 1171 or the receiving portion adhesive member 1172 may be disposed on the first side and the second side. In some embodiments, both the wing portion adhesive member 1171 and the receiving portion adhesive member 1172 may be disposed on the first side and the second side.

Referring to FIG. 11, an adhesive member 117 may be disposed in a specific pattern in the attachment region where the wing portion 127 and the receiving portion 126 are in contact with each other. In some embodiments, the adhesive member 117 may extend in the entirety or at least a portion of the attachment region where the wing portion 127 and the receiving portion 126 are in contact with each other. In some embodiments, the adhesive member 117 may be disposed having a dot geometry. The dot geometry may allow for an increase in the lateral separation distance. The dots may be disposed along a straight line, disposed in a zigzag geometry along two or more lines, or disposed in a C-shape geometry or an S-shape geometry along two or more lines.

Referring to FIG. 12, an adhesive member 117 may be disposed along a straight line geometry in an attachment region where a wing portion 127 and a receiving portion 126 contact each other. In some embodiments, the adhesive member 117 may be disposed along the entirety or at least a portion of the attachment region where the wing portion 127 and the receiving portion 126 are in contact with each other. In some embodiments, the adhesive member 117 may be disposed along a straight line, disposed in a zigzag geometry along two or more lines, or disposed in a C-shape geometry or an S-shape geometry along two or more lines.

In some embodiments, the adhesive member 117 may include the same material as the adhesive member 116 or may include different materials. In some embodiments, the adhesive member 116 may include an adhesive tape, and the adhesive member 117 may include an adhesive.

FIG. 13 shows a smartphone 1000 equipped with a secondary battery 10 according to embodiments of the present disclosure.

As shown in FIG. 13, a secondary battery 10 may be a small battery mounted in a small portable device such as a smartphone 1000. In this case, because the exemplary secondary battery 10 is configured to be able to increase the capacity thereof while having a slim internal structure, the secondary battery 10 may be a battery suitable for application to small portable devices. As used herein, the terms “secondary battery” and “battery” have the same meaning and are different only in expression for convenience of description.

The secondary battery may be increased in size to be used to manufacture a battery pack.

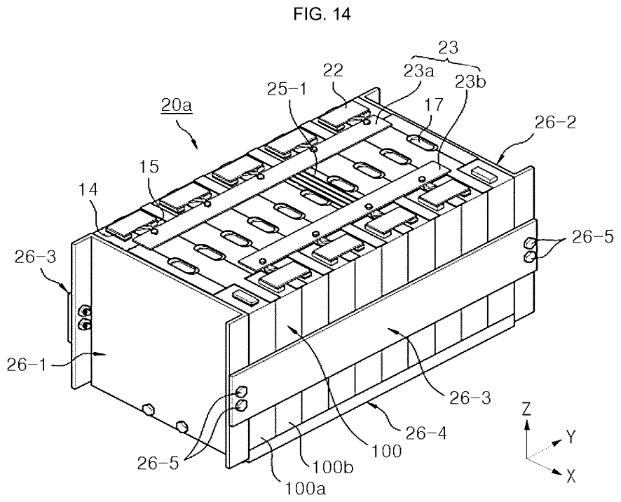

FIG. 14 is a perspective view showing a battery module 20a according to embodiments of the present disclosure.

Referring to FIG. 14, the battery module 20a includes electrode portions 14 and 15, a plurality of battery cells 100 arranged in one direction, a connection tab 22 connecting a battery cell 100a to an adjacent battery cell 100b, and a protection circuit module 23 having one end connected to the connection tab 22. The protection circuit module 23 may be a battery management system (BMS). In addition, the connection tab 22 includes a body portion that is in contact with the electrode portions 14 and 15 between neighboring battery cells 100a and 100b and an extension portion that extends from the body portion and is connected to the protection circuit module 23. The connection tab 22 may be a bus bar.

The battery cell 100 may include a battery case, an electrode stack housed in the battery case, and an electrolyte. The electrode stack and the electrolyte react electrochemically to generate energy. One side of the battery cell 100 may be provided with terminal portions 14 and 15 electrically connected to a connection tab 22, and a vent 17 as an exhaust passage for the gas that is generated internally. The terminals 14 and 15 of the battery cells 100 may be a negative electrode terminal 14 and a positive electrode terminal 15 having different polarities, and the terminals 14 and 15 of neighboring battery cells 100a and 100b nay be electrically connected in series or in parallel by the connection tab 22 which will be described below. The present disclosure is not limited to this structure, and various connection structures may be adopted as needed. In addition, the number and arrangement of battery cells are not limited to the structure shown in FIG. 14 and may be changed as needed.

A plurality of battery cells 100 may be arranged in one direction so that the wide-area surfaces of the battery cells 100 face each other, and the arranged plurality of battery cells 100 may be fixed by housings 26-1, 26-2, 26-3, and 26-4. The housings 26-1, 26-2, 26-3, and 26-4 may include a pair of end plates 26-1 and 26-2 facing the wide-area surfaces of the battery cell 100, a side plate 26-3 connecting the pair of end plates 26-1 and 26-2, and a bottom plate 26-4. The side plate 26-3 may support the side surface of the battery cell 100, and the bottom plate 26-4 may support the bottom surface of the battery cell 100. In addition, the pair of end plates 26-1 and 26-2, the side plate 26-3, and the bottom plate 26-4 may be connected by means of a member, such as a bolt 26-5. In some embodiments, the bottom plate 26-4 may include or be referred to as a cooling plate.

The protection circuit module 23 mounts electronic components and protection circuits, and may be electrically connected to the connection tab 22 which will be described below. The protection circuit module 23 may include a first protection circuit module 23a and a second protection circuit module 23b extending at different locations along the direction in which the plurality of battery cells 100 are arranged, where the first protection circuit module 23a and the second protection circuit module 23b are positioned parallel to each other while being spaced apart from each other by a certain distance, and may be electrically connected to the connection tab 22 that is adjacent thereto, respectively. For example, the first protection circuit module 23a is formed to extend from one upper side of the plurality of battery cells 100 along the direction in which the plurality of battery cells 100 are arranged, and the second protection circuit module 23b is formed to extend from the other upper side of the plurality of battery cells 100 along the direction in which the plurality of battery cells 100 are arranged. Here, the second protection circuit module 23b is positioned to be spaced apart from the first protection circuit module 23a by a certain distance with the vent 17 interposed therebetween, but may be arranged parallel to the first protection circuit module 23a. In this way, the two protection circuit modules are arranged in parallel and spaced apart from each other along the direction in which a plurality battery cells are arranged, thereby minimizing the area of a printed circuit board (PCB) that constitutes the protection circuit module. By configuring the protection circuit module as two separate protection circuit modules, an unnecessary area of the PCM can be minimized. In addition, the first protection circuit module 23a and the second protection circuit module 23b may be connected to each other by a conductive connecting member 25-1. Here, one side of the connecting member 25-1 is connected to the first protection circuit module 23a, and the other side is connected to the second protection circuit module 23b, thereby achieving an electrical connection can be made between the two protection circuit modules.

The connection may be performed by any one of soldering, resistance welding, laser welding, or projection welding.

In addition, the connecting member 25-1 may be, for example, an electric wire. In addition, the connecting member 25-1 may be made of a material having elasticity or flexibility. By means of the connecting member 25-1, the voltage, temperature, and current of the plurality of battery cells 100A may be checked and managed to be normal. That is, information such as voltage, current, and temperature received by the first protection circuit module from the connection tab that is adjacent thereto and information such as voltage, current, and temperature received by the second protection circuit module from the connection tab that is adjacent thereto may be integrated and managed by the protection circuit module through the connecting member.

In addition, when the battery cell 100 swells, the shock may be absorbed by the elasticity or flexibility of the connecting member 25-1, thereby preventing the first and second protection circuit modules 23a and 23b from being damaged.

In addition, the shape or structure of connecting member 25-1 are not limited to that shown in FIG. 14.

In this way, since the protection circuit module 23 includes the first and second protection circuit modules 23a and 23b, the area of the PCB constituting the protection circuit module can be minimized, thereby securing a space inside the battery module. This improves work efficiency by facilitating repair when an abnormality is detected in the battery module as well as a fastening work of connecting the connection tab 22 and the protection circuit module 23.

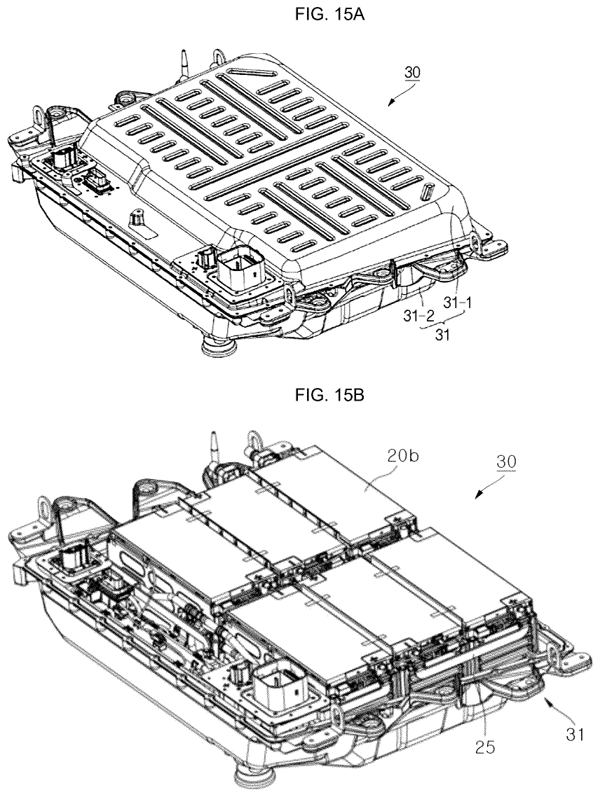

FIGS. 15A and 15B are perspective views of a battery pack 30 according to embodiments of the present disclosure.

The battery pack 30 may include a plurality of battery modules 20b and a housing 31 for accommodating the plurality of battery modules 20b. For example, the housing 31 may include first and second housings 31-1 and 31-2 coupled in opposite directions through the plurality of battery modules 20b. The plurality of battery modules 20b may be electrically connected to each other by using a bus bar 25-1, and the plurality of battery modules 20b may be electrically connected to each other in a series/parallel or series-parallel mixed method, thereby obtaining required electrical output.

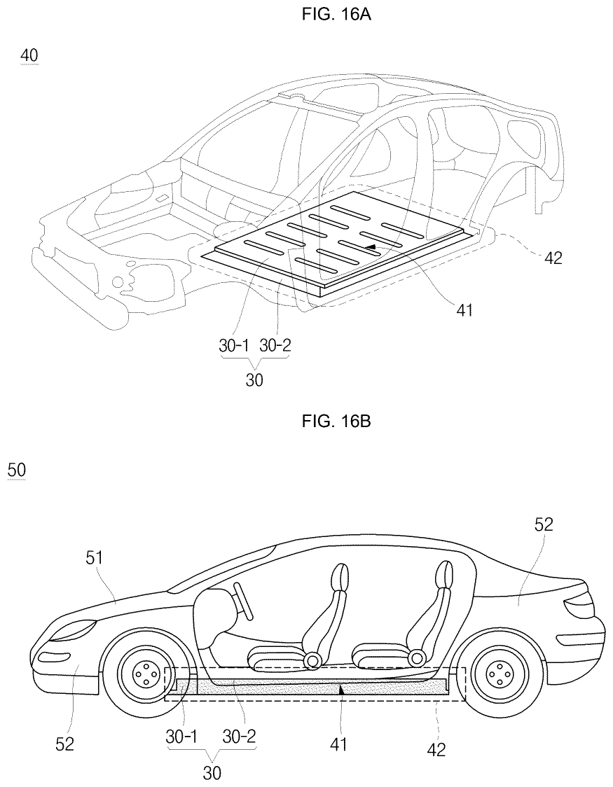

FIG. 16A is a perspective view showing a vehicle body 40 and vehicle components according to embodiments of the present disclosure. FIG. 16B is a side view showing a vehicle body 40 and vehicle components according to embodiments of the present disclosure

In FIG. 16A, a battery pack 30 may include a battery pack cover 30-1, which is a part of a vehicle underbody 41, and a pack frame 30-2 located under the vehicle underbody 41. In some examples, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 30-2 may be located outside the vehicle.

Referring to FIG. 16B, a vehicle 50 may be formed by combining additional parts, such as a hood 51 in front of the vehicle and fenders 52 respectively located in the front and rear of the vehicle to a vehicle body 40. The vehicle 50 may include the battery pack 30 that include the battery pack cover 30-1 and the pack frame 30-2, and the battery pack 30 may be coupled to the vehicle body 40.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery, comprising:
an electrode assembly comprising a plurality of first electrode plates, a plurality of second electrode plates, and a separator, the separator folded in a zigzag geometry and interposed between each of the plurality of first electrode plates and each of the plurality of second electrode plates;
a case accommodating the electrode assembly; and
an adhesive member disposed on at least one side of an outer surface of the electrode assembly,
wherein the electrode assembly has an adhesion region in which an outermost end region of the separator is adhered, and
wherein the adhesive member is disposed on at least a portion of the adhesion region.

2. The secondary battery as claimed in claim 1, wherein the adhesive member is disposed on a first side of the electrode assembly where the outermost end region of the separator is located and disposed on a second side opposite to the first side.

3. The secondary battery as claimed in claim 2, wherein the adhesion region is located in at least one of a plurality of bent regions.

4. The secondary battery as claimed in claim 3, wherein the plurality of first electrode plates or the plurality of second electrode plates are exposed,
wherein the adhesive member is disposed on an outer surface of the plurality of bent regions on the second side, and disposed at an end of the plurality of first electrode plates or an end of the plurality of second electrode plates, and
wherein the adhesive member is disposed at the outermost end region of the separator on the first side, on the outer surface of the plurality of bent regions other than the adhesion region, at an end of a front end region of the separator, an end of the plurality of first electrode plates, and/or an end of the plurality of second electrode plates.

5. The secondary battery as claimed in claim 3, wherein the separator is exposed,
wherein the adhesive member is disposed on an outer surface of the plurality of bent regions on the second side, and disposed at an end of the plurality of first electrode plates or an end of the plurality of second electrode plates, and
wherein the adhesive member is disposed at the outermost end region of the separator on the first side, on the outer surface of the plurality of bent regions other than the adhesion region, at an end of a front end region of the separator, an end of the plurality of first electrode plates, and/or an end of the plurality of second electrode plates.

6. The secondary battery as claimed in claim 3, wherein the adhesion region is located along an entirety of the plurality of bent regions and located at an end of a front end region of the separator.

7. The secondary battery as claimed in claim 6, wherein the plurality of first electrode plates or the plurality of second electrode plates are exposed,
wherein the adhesive member is disposed on an outer surface of the plurality of bent regions on the second side, and disposed at an end of the plurality of first electrode plates or an end of the plurality of second electrode plates, and
wherein the adhesive member is disposed at the outermost end region of the separator on the first side, an end of the plurality of first electrode plates, and/or an end of the plurality of second electrode plates.

8. The secondary battery as claimed in claim 6, wherein the separator is exposed,
wherein the adhesive member is disposed at the plurality of bent regions on the second side, and disposed at an end of the plurality of first electrode plates or an end of the plurality of second electrode plates, and
wherein the adhesive member is disposed at the outermost end region of the separator on the first side.

9. The secondary battery as claimed in claim 6, wherein the outermost end region and the front end region have ends in contact with each other.

10. The secondary battery as claimed in claim 2, wherein a length of the outermost end region is less than or equal to a stacking-direction height of the electrode assembly.

11. The secondary battery as claimed in claim 1, wherein the adhesive member is disposed on an outer surface of the outermost end region of the separator.

12. The secondary battery as claimed in claim 1, wherein the adhesive member is disposed on an interior side of the outermost end region of the separator.

13. The secondary battery as claimed in claim 1, wherein the adhesive member is disposed along a periphery of at least a portion of the electrode assembly in the longitudinal direction.

14. The secondary battery as claimed in claim 1, wherein the adhesive member is disposed on an entirety of the outer surface of the electrode assembly.

15. The secondary battery as claimed in claim 1, wherein the adhesive member is disposed on an entirety of the outer surface of the electrode assembly excluding an electrolyte injection region.

16. The secondary battery as claimed in claim 1, wherein the case comprises:
a plurality of wing portions formed at least one side of the case; and
a receiving portion between each of the plurality of wing portions,
wherein the adhesive member is disposed at the plurality of wing portions or in the receiving portion.

17. The secondary battery as claimed in claim 16, wherein the adhesive member includes an adhesive tape or an adhesive.

18. The secondary battery as claimed in claim 16, wherein the adhesive member is disposed in a specific pattern on a portion of an attachment region where the plurality of wing portions and the receiving portion are in contact with each other.

19. The secondary battery as claimed in claim 1, wherein the plurality of first electrode plates is disposed on a lower side of the separator, wherein the plurality of second electrode plates is disposed on an upper side of the separator, and wherein the separator or the plurality of first electrode plates are exposed to a front side and/or a rear side of the electrode assembly.

20. The secondary battery as claimed in claim 1, wherein the plurality of second electrode plates is disposed on a lower side of the separator, wherein the plurality of first electrode plates is disposed on an upper side of the separator, and wherein the separator or the plurality of second electrode plates are exposed to a front side and/or a rear side of the electrode assembly.
